(19) United States
(12) Patent Application Publication
(10) Pub. No.: US 2018/0287398 A1
(43) Pub. Date: Oct. 4, 2018

(54) REDUNDANT ELECTRIC POWER ARCHITECTURE

(71) Applicant: Kitty Hawk Corporation, Mountain View, CA (US)

(72) Inventors: John Melack, Redwood City, CA (US); Thomas P. Muniz, Sunnyvale, CA (US)

(21) Appl. No.: 15/471,971

(22) Filed: Mar. 28, 2017

(51) Int. Cl. H02J 7/00; B64D 27/24

(52) U.S. Cl. CPC H02J 7/0021; B64D 2221/00; B64D 27/24; H02J 7/0045

(57) ABSTRACT

A redundant electric power architecture is disclosed. The architecture includes multiple batteries in parallel. Each battery is in series with a diode. The diodes are each connected to a load.

### BACKGROUND OF THE INVENTION

Electric aircraft may store batteries onboard that are used to power the aircraft. Redundancy measures related to the batteries and powering the aircraft may be critical to ensure flight safety. A system that eliminates single points of failure or provides error alerts may be desired.

### BRIEF DESCRIPTION OF THE DRAWINGS

Various embodiments of the invention are disclosed in the following detailed description and the accompanying drawings.

FIG. 1 is a diagram illustrating an embodiment of redundant electric power architecture comprising parallel batteries and diodes.

FIG. 2 is a diagram illustrating an embodiment of redundant electric power architecture comprising parallel batteries and diodes.

FIG. 3A is a diagram illustrating an embodiment of a fin heat sink on a diode.

FIG. 3B is a diagram illustrating an embodiment of a fan-cooled heat sink on a diode.

FIG. 4 is a diagram illustrating an embodiment of redundant electric power architecture comprising distributed wiring.

FIG. 5 is a diagram illustrating an embodiment of redundant electric power architecture comprising distributed wiring.

FIG. 6 is a diagram illustrating an embodiment of parallel diodes.

FIG. 7 is a diagram illustrating an embodiment of parallel current sensing.

FIG. 8 is a flow diagram illustrating an embodiment of a current sensor process.

FIG. 9 is a flow diagram illustrating an embodiment of current sensor process.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A redundant electric power architecture is disclosed. The architecture comprises a plurality of batteries in parallel and a plurality of diodes. Each diode of the plurality of diodes is in series with a corresponding battery of the plurality of batteries. The architecture further comprises a load connected to the plurality of diodes. The architecture may be utilized in an electric aircraft; the load may be configured to fly an electric aircraft. The plurality of parallel batteries may prevent a single battery failure from impacting flight of the aircraft. The plurality of diodes may prevent the parallel batteries from interfering with each other. The batteries may be wired individually to loads of the aircraft. In some embodiments, current sensors are used in series with the plurality of diodes to detect diode failures.

An electric aircraft may be powered by batteries stowed on the aircraft. The electric aircraft may require redundant design surrounding the installation of the batteries because failure to power the aircraft may greatly endanger people onboard or on land. Multiple redundancy measures may be designed in the architecture, such as parallel batteries and distributed wiring. Diodes may be used to ensure charge does not travel from one parallel battery to another. The aircraft may utilize high voltage batteries, which require usage of parallel diodes. Current sensors may be used to detect irregularities in the parallel diodes. The architecture may be used in other various applications, such as an electric car.

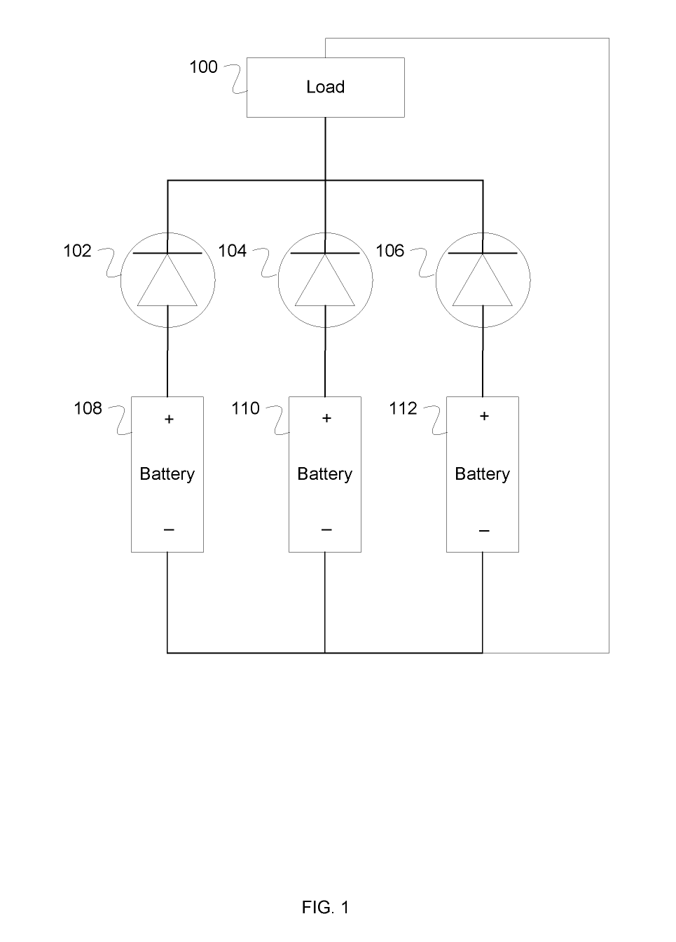

FIG. 1 is a diagram illustrating an embodiment of redundant electric power architecture comprising parallel batteries and diodes. Arranging batteries in parallel may provide redundancy to an aircraft. In the event the batteries are in series, a single failed battery may prevent the aircraft from being powered. In the event the batteries are in parallel, multiple paths from a load of the aircraft to ground may exist. The aircraft may maintain full performance in the event of a battery failure so long as one battery is functioning. In the example shown, battery 108, battery 110, and battery 112 are in parallel. In various embodiments, 4, 6, 10, or any appropriate number of parallel batteries are used. In some embodiments, the number of parallel batteries used may be based upon weight considerations or physical constraints of the aircraft.

As shown, battery 108 is wired to diode 102, battery 110 is wired to diode 104, and battery 112 is wired to diode 106. The batteries may be high voltage (e.g. 1000 Volt batteries). Batteries 108, 110, and 1112 as shown are wired on their other end to a high voltage ground. Diodes 102, 104, and 106 are wired to load 100. Load 100 may comprise a component of the aircraft that is powered by the batteries. For example, load 100 may comprise a motor, a fan, a processor, avionics, or any appropriate load. The diodes allow current to flow in one direction but prevent current from flowing in the opposite direction. In the example shown, the diodes may allow current to flow toward load 100 and prevent current from flowing toward the batteries. In some embodiments, parallel batteries used are identical. However, various factors may cause the batteries to be at different voltages (e.g. age, defects). A higher voltage battery in parallel with a lower voltage battery without diodes present may result in charge flowing from the higher voltage battery to the lower voltage battery, causing battery failure. Diodes may electrically isolate the parallel batteries, preventing charge shuttling between the batteries and providing a protective measure. The presence and placement of diodes in relation to the parallel batteries may enable the batteries to operate as independent entities.

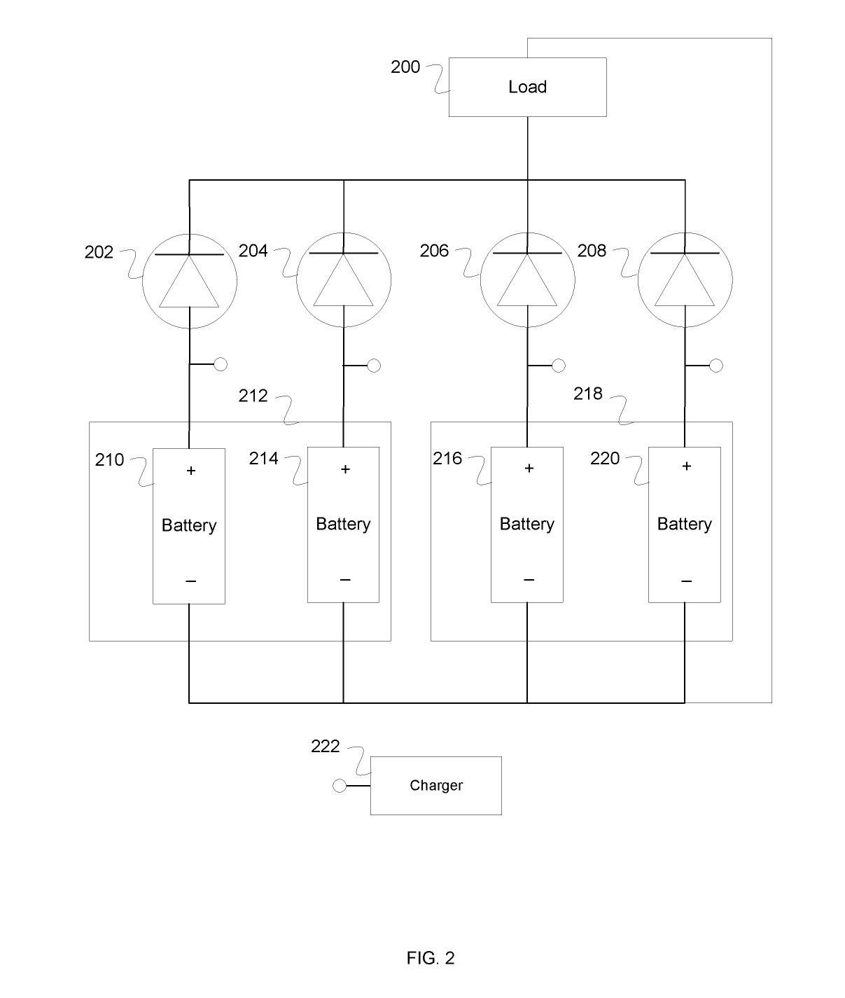

FIG. 2 is a diagram illustrating an embodiment of redundant electric power architecture comprising parallel batteries and diodes. The parallel batteries may each be connected to a charger. In some embodiments, each battery comprises its own independent charger. In some embodiments, a single charger charges all the batteries.

A parallel battery, for the purposes of the invention, describes an entire battery that connects a load of the aircraft and an electrical ground. A parallel battery may comprise a plurality of batteries or battery cells. A parallel battery may comprise multiple batteries both arranged in series and in parallel. The multiple batteries may be installed on battery management boards. For example, one parallel battery may comprise twelve battery management boards and 36 batteries. A management system may be present for each parallel battery. The management system may check cell voltages, capacities, or any appropriate battery measurement. In the event of an irregularity, an alert may be sent to a pilot, an error may be logged, the battery may be deactivated, or any appropriate action may be taken.

The parallel batteries may be arranged in packs and placed in the aircraft. In the example, battery pack 212 comprises battery 210 and battery 214. Battery 212 and battery 214 may be stored in a shared frame, creating battery pack 212. In the example shown, battery pack 218 comprises battery 216 and battery 220. The battery packs may be stored in different locations on the aircraft. In various embodiments, the parallel batteries may be configured into packs of various sizes. The batteries as shown are wired to charger 222.

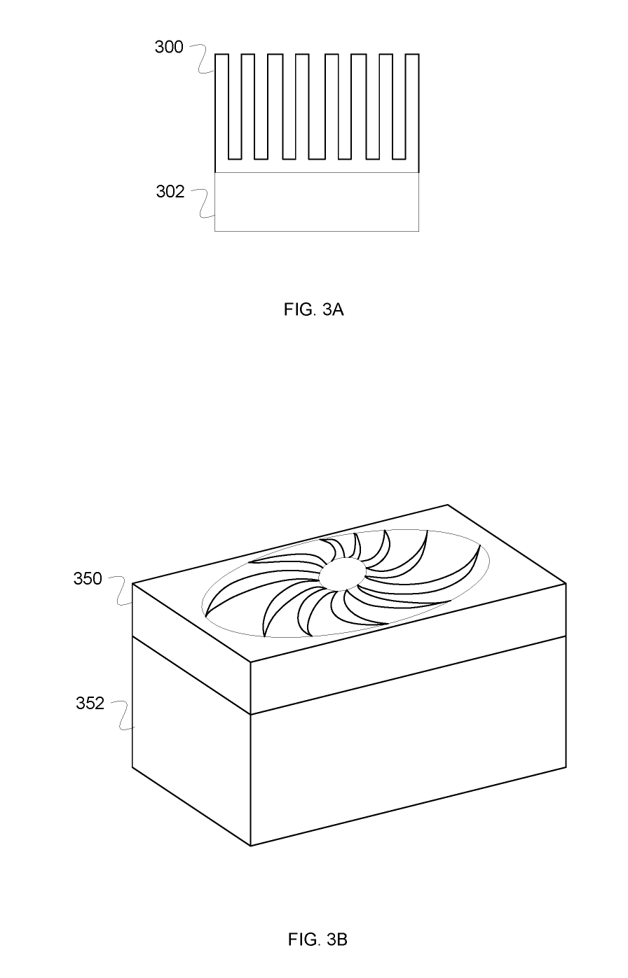

FIG. 3A is a diagram illustrating an embodiment of a fin heat sink on a diode. Diodes may create heat that is undesired in the aircraft. Various heat dissipation techniques may be employed. Passive heat sinks may be used. In the example shown, fin heat sink 300 is positioned on diode 302. Fin heat sink 300 may comprise materials with high thermal conductivity values.

FIG. 3B is a diagram illustrating an embodiment of a fan-cooled heat sink on a diode. In the example shown, fan 350 is positioned on top of diode 352. A fan may transfer heat away from the diode. In some embodiments, a fan is used to blow air on the diode.

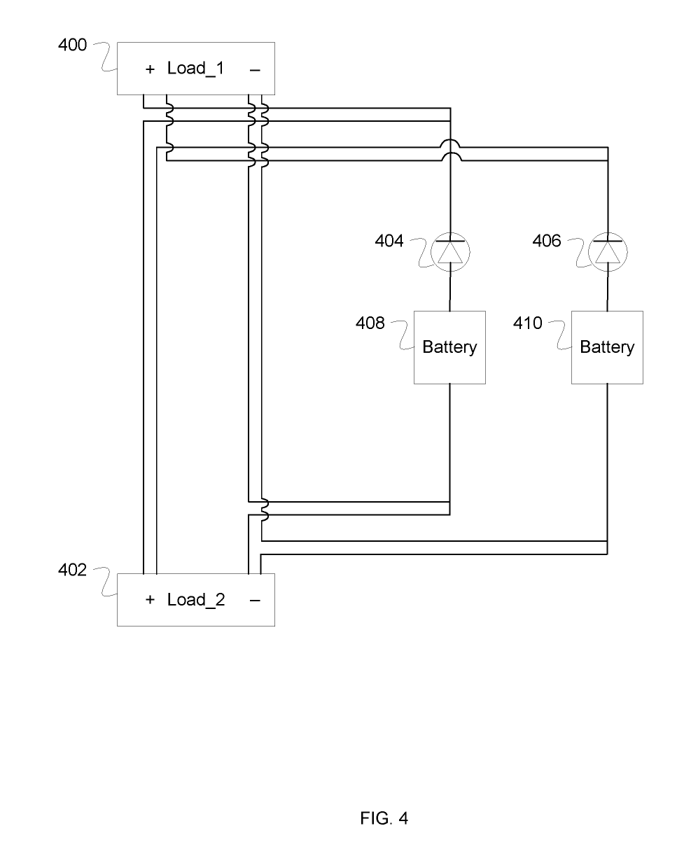

FIG. 4 is a diagram illustrating an embodiment of redundant electric power architecture comprising distributed wiring. In some embodiments, the parallel batteries may converge on a shared line. Loads of the aircraft may be connected to the shared line (e.g. a high voltage line), allowing the multiple loads to be powered. The parallel batteries may share a positive bus and a negative bus.

In some embodiments, the wiring is distributed and each parallel battery is independently wired to each individual load. With distributed wiring, the parallel batteries do not share positive and negative buses. For example, an electric aircraft may comprise twelve lift fans and three forward propulsion motors that require power. Each parallel battery of the aircraft may be individually wired to each fan and motor.

Distributed wiring may eliminate a single point of failure in the aircraft by providing redundancy. In the event a short occurs between the positive and negative terminals of one battery, only the one battery may be affected. The loads of the aircraft may remain powered and unaffected due to connections to other batteries. Each load may be individually wired to every parallel battery in the system. A large wire harness may be utilized due to the many wires. The wires may be insulated.

In the example shown, battery 408 is wired to load_1 400 separately from battery 410, which is also wired to load_1 400. Similarly, battery 408 is wired to load_2 402 separately from battery 410, which is also wired to load_2 402. As shown, battery 408 is wired to diode 404. The wire coming out of diode 404 splits and is connected to the positive terminals of loads 400 and 402. Battery 410 is wired to diode 406. The wire coming out of diode 406 splits and is connected to the positive terminals of loads 400 and 402. A wire leads from battery 408 to the negative terminals of load_1 400 and load_2 402. A separate wire leads from battery 410 to the negative terminals of load_1 400 and load_2 402.

The most redundancy may be achieved in the event every battery is individually wired to every load. In some embodiments, the parallel batteries may be grouped together (e.g. in a pack) wherein each group is connected to a shared positive bus and a shared negative bus. Each group may be separately wired to every load.

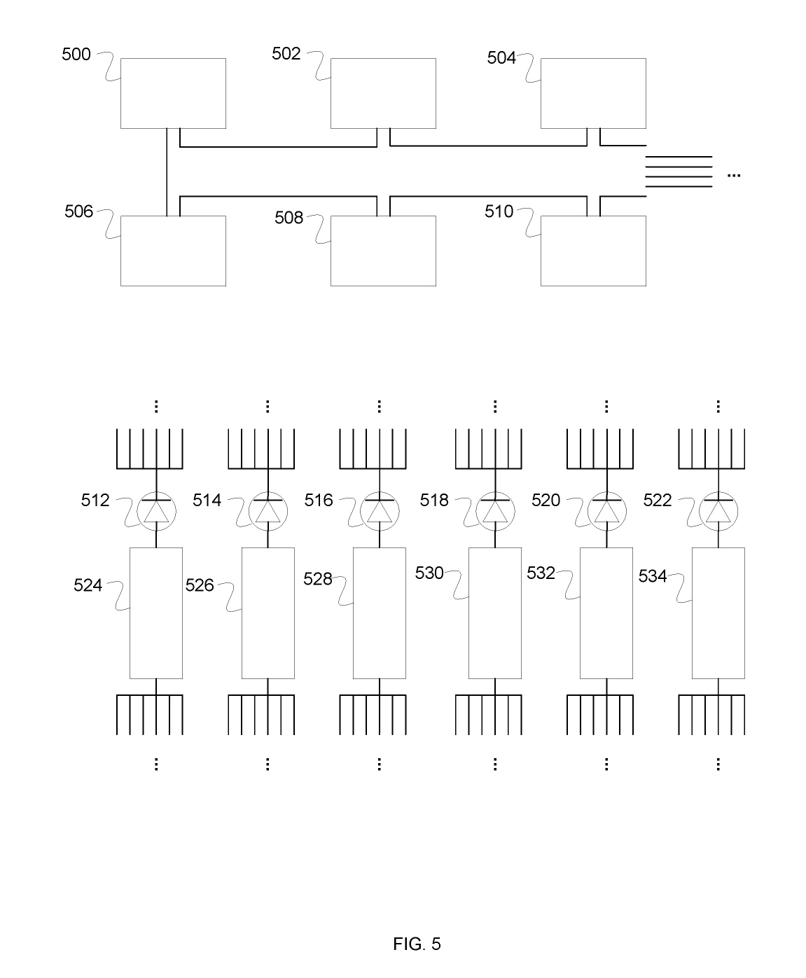

FIG. 5 is a diagram illustrating an embodiment of redundant electric power architecture comprising distributed wiring. Aircraft loads 500, 502, 504, 506, 508, and 510 are shown. The six loads may be present on one wing of the aircraft. In some embodiments, another six loads are present on another wing of the aircraft. As shown, battery 524 is in series with diode 512, battery 526 is in series with diode 514, battery 528 is in series with diode 516, battery 530 is in series with diode 518, battery 532 is in series with diode 520, and battery 534 is in series with diode 522. The batteries are in parallel with each other. Each parallel battery shown comprises its own wiring to the six loads. Each battery as shown has six wires attached at its positive terminal and six wires attached at its negative terminal. The six wires attached at the positive terminal may each connect the battery to a positive terminal of one of the six loads. The six wires attached at the negative terminal may connect the battery to negative terminals of the six loads.

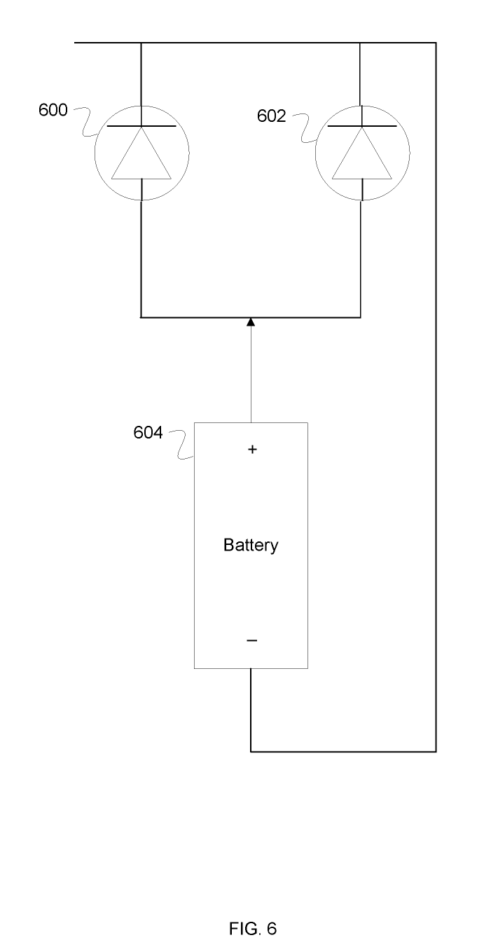

FIG. 6 is a diagram illustrating an embodiment of parallel diodes. In some embodiments, the batteries used are high voltage and correspondingly large currents are created. Diodes capable of handling the large currents may be inaccessible or cost prohibitive. Parallel diodes may be used in order to handle the large current. In the example shown, diodes 600 and 602 are in parallel. The diodes are connected to battery 604. Equal currents may flow through diodes 600 and 602. Rather than a large current flowing through one diode, half of the large current may flow through each parallel diode. In some embodiments, three or more diodes may be used in parallel.

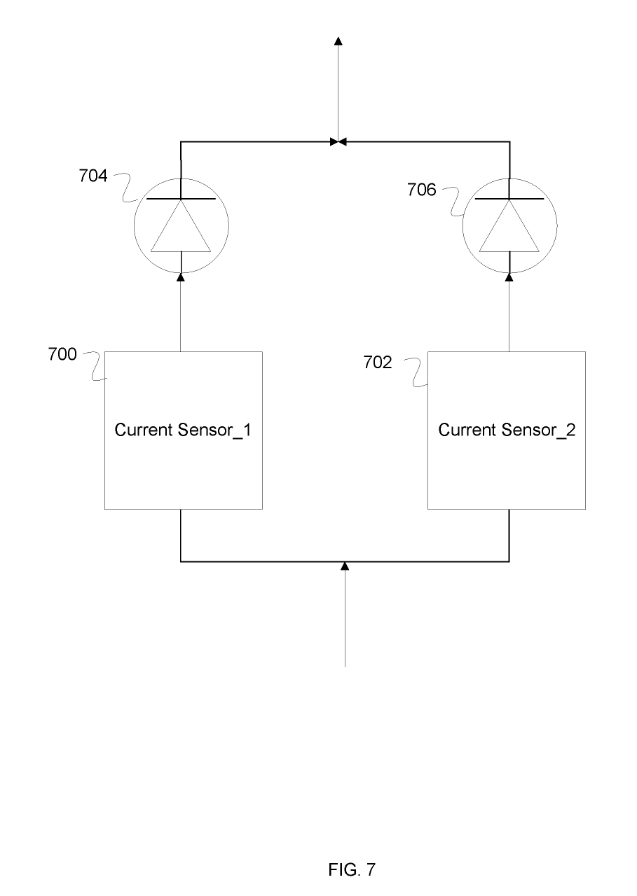

FIG. 7 is a diagram illustrating an embodiment of parallel current sensing. In some embodiments, one diode of the parallel diodes may fail. A diode that fails open (e.g. breaking the connection) may cause a larger current than expected to flow through a remaining parallel diode. The remaining parallel diode may fail to function properly as a result. In the event all parallel diodes are failed, the battery may fail to properly power the aircraft. In some embodiments, quickly detecting and addressing a single parallel diode failure may limit the impact of the failure.

Current sensors may be used to determine whether a diode is functioning correctly. For example, the current sensors may be used to determine whether an expected amount of current is flowing through each diode. In the event an unexpected amount of current is detected, an error may be detected. Following detection, the error may be reported to a pilot or an external data logging center. The error may trigger an automatic deactivation of the corresponding battery.

In the example shown, current sensor_1 700 and diode 704 are in series. Current sensor_2 702 and diode 706 are in series. Current sensor_1 700 and diode 704 are in parallel with current sensor_2 702 and diode 706. As shown, each parallel diode has its own current sensor that measures current flowing into the diode. In some embodiments, the current sensors measure current flowing out of the diode.

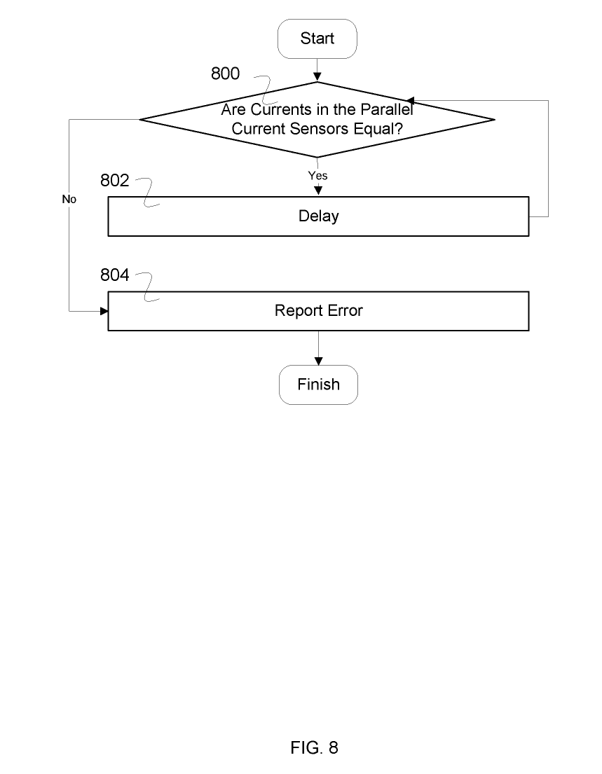

FIG. 8 is a flow diagram illustrating an embodiment of a current sensor process. At 800, it is determined if the currents in the parallel current sensors are equal. In the event that the currents are equal, at 802 the process is delayed before the process returns to 800. In some embodiments, the delay may be a predetermined amount of time. For example, the process may constantly check whether the currents are equal every second or every few milliseconds. In the event the currents in the parallel current sensors are not equal, at 804 an error is reported. The error may be reported to a pilot, a controller at ground, a data logging system, or any appropriate body.

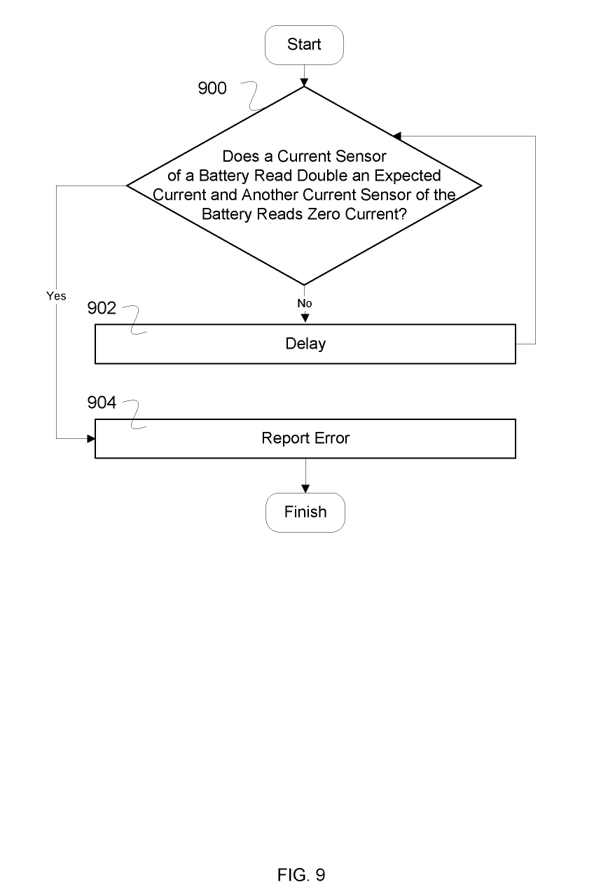

FIG. 9 is a flow diagram illustrating an embodiment of current sensor process. In the event two parallel diodes are used, failure of one diode in an open state may cause the entire current to flow through the remaining diode and zero current to flow through the failed diode. At 900, it is determined whether a current sensor of a battery reads double an expected current and the other current sensor reads zero current. The determination if true may indicate that a diode has failed open and if false may indicate a diode has not failed open. In the event the current sensor of a battery does not read double the expected current and the other current sensor does not read zero current, at 902 the process is delayed before returning to 900. The delay may comprise a predetermined amount of time. The process at 900 may be repeated on a set schedule. In the event a current sensor of the battery does read double the expected current and the other current sensor does not read zero current, in 902 the error is reported.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A redundant electric power architecture, comprising:
a plurality of batteries in parallel;
a plurality of diodes, each diode of the plurality of diodes being in series with a corresponding battery of the plurality of batteries; and
a load connected to the plurality of diodes.

2. The architecture of claim 1, wherein the plurality of diodes allow current to flow from the plurality of batteries to the load and prevent current from flowing into the plurality of batteries.

3. The architecture of claim 1, wherein the plurality of batteries, the plurality of diodes, and the load are stored in an electric aircraft.

4. The architecture of claim 1, wherein the load comprises a fan, motor, or processor.

5. The architecture of claim 1, wherein the plurality of diodes are connected to the load via a shared bus.

6. The architecture of claim 1, wherein the plurality of diodes are connected to the load via is separate wires.

7. The architecture of claim 1, comprising one or more additional loads.

8. The architecture of claim 7, wherein the load and the one or more additional loads are separately wired to each battery of the plurality of batteries.

9. The architecture of claim 1, wherein a battery of the plurality of batteries is in series with two parallel diodes, comprising a diode of the plurality of diodes and an additional diode.

10. The architecture of claim 9, wherein the diode of the plurality of diodes is in series with a first current sensor and the additional diode is in series with a second current sensor, wherein the first current sensor and the second current sensor are in parallel.

11. The architecture of claim 10, wherein the first current sensor and the second current sensor are monitored.

12. The architecture of claim 10, wherein in the event the first current sensor provides a current reading double an expected current and the second current sensor provides a current reading of zero, a diode failure is signaled.

13. The architecture of claim 10, wherein in the event the first current sensor provides a different current reading from the second current sensor, a diode failure is signaled.

14. The architecture of claim 13, wherein signaling a diode failure comprising providing an error message or deactivating a battery.

15. The architecture of claim 1, wherein the plurality of batteries comprises a battery management system.

16. The architecture of claim 1, wherein a diode of the plurality of diodes comprises a heat sink.

17. The architecture of claim 16, wherein the heat sink comprises cooling fins.

18. The architecture of claim 16, wherein the heat sink comprises a fan.
